(19) United States
(12) Patent Application Publication
(10) Pub. No.: US 2013/0052898 A1
(43) Pub. Date: Feb. 28, 2013

(54) Method and Semi-Product for Making Artificial Leather

(71) Applicant: Hsi-Chin Lo, Taichung City (TW)

(72) Inventor: Hsi-Chin Lo, Taichung City (TW)

(73) Assignee: FENG SHERN ENTERPRISE CO., LTD, Taichung City (TW)

(21) Appl. No.: 13/218,854

(22) Filed: Aug. 26, 2011

(51) Int. Cl. B32B 5/02; B05D 3/02; B05D 5/02

(52) U.S. Cl. 442/59; 427/256

(57) ABSTRACT

A method of making artificial leather includes: applying on a fabric substrate a coating layer that includes a mixture of a resin and a gas bubble material; and heating the fabric substrate and the coating layer until the gas bubble material bursts and breaks the coating layer to open and form hairy filaments. A semi-product includes the fabric substrate, and the coating layer disposed on the fabric substrate. The coating layer includes a mixture of the resin and the gas bubble material that is burstable under heat to cause the coating layer to break into hairy filaments.

### BACKGROUND OF THE INVENTION

1. Field of the Invention

The invention relates to an artifical leather, and more particularly, to a method and a semi-product for making an artificial leather.

2. Description of the Related Art

Deer skin leather has a glossy color and is fairly soft and comfortable to feel. However, because supply of natural deer skin leather is insufficient to satisfy the demand of consumers, artificial deer skin leather has been developed to substitute the natural deer skin leather.

FIG. 1 shows an artificial deer skin sheet 1 that includes a substrate 11 having a plurality of fine fibrils 12. Typically, artificial deer skin leather is fabricated by using a substrate 11 made of a superfine fibrous material and impregnated with a polymeric coating such as a polyurethane coating. The substrate 11 with the polyurethane coating is water washed and dried, and the surface of the impregnated substrate 11 is buffed using a sander or buffing machine to draw out superfine fibrils from the substrate 11, which are then trimmed to form the fine fibrils 12. Examples of fabrication methods for artificial deer skin leathers are disclosed in Taiwanese Application Nos. 91117592 and 92126775.

However, the buffing action on the surface of the impregnated substrate 11 tends to result in a color displacement of the fibrils 12, producing uneven deep and light colors in the artificial deer skin leather. In addition, because the length of the fibrils 12 can vary with the changing pressure of the buffing action, it is difficult to obtain an artificial deer skin leather with satisfactory quality.

### SUMMARY OF THE INVENTION

An object of the present invention is to provide a method for making an artificial leather without employing any buffing action that is unfavorable to color and gloss level of the artificial leather.

Another object of the present invention is to provide a semi-product for making an artificial leather, which can provide uniform color and gloss level for the artificial leather.

According to one aspect of the present invention, a method of making artificial leather, comprises: applying on a fabric substrate a coating layer that includes a mixture of a resin and a gas bubble material; and heating the fabric substrate and the coating layer until the gas bubble material bursts and breaks the coating layer to open and form hairy filaments.

According to another aspect of the present invention, a semi-product for forming artificial leather, comprises a fabric substrate, and a coating layer disposed on the fabric substrate. The coating layer includes a mixture of a resin and a gas bubble material that is burstable under heat to cause the coating layer to break into hairy filaments.

### BRIEF DESCRIPTION OF THE DRAWINGS

Other features and advantages of the present invention will become apparent in the following detailed description of the preferred embodiment with reference to the accompanying drawings, of which:

FIG. 1 shows a conventional artificial leather;

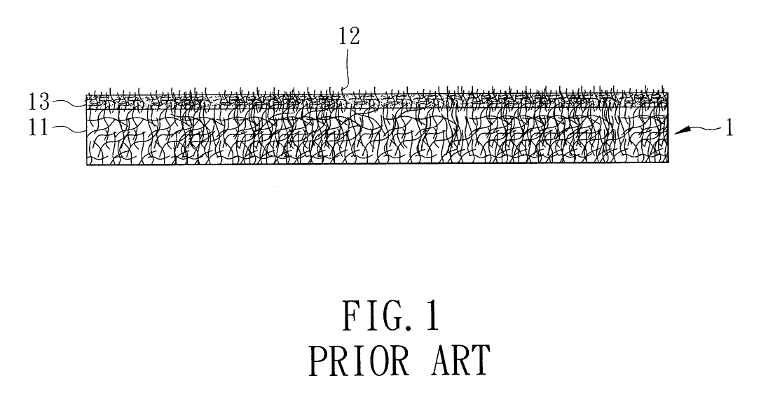

FIG. 2 is an elevation view of a semi-product for making an artificial leather according to the present invention;

FIG. 3 is an enlarged sectional view of the semi-product shown in FIG. 2; and

FIG. 4 is an enlarged sectional view of the artificial leather that is formed from the semi-product of FIG. 3 after a gas bubble material bursts.

### DETAILED DESCRIPTION OF THE PREFERRED EMBODIMENT

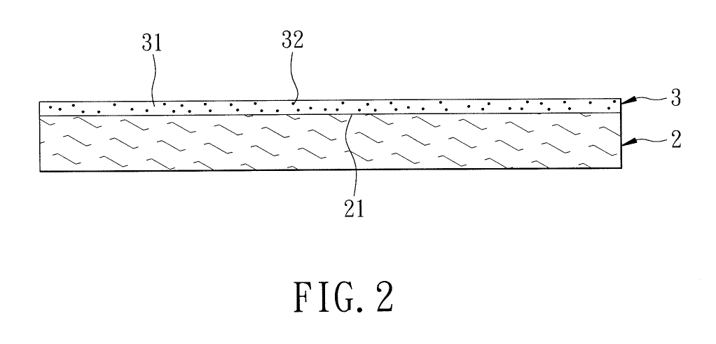

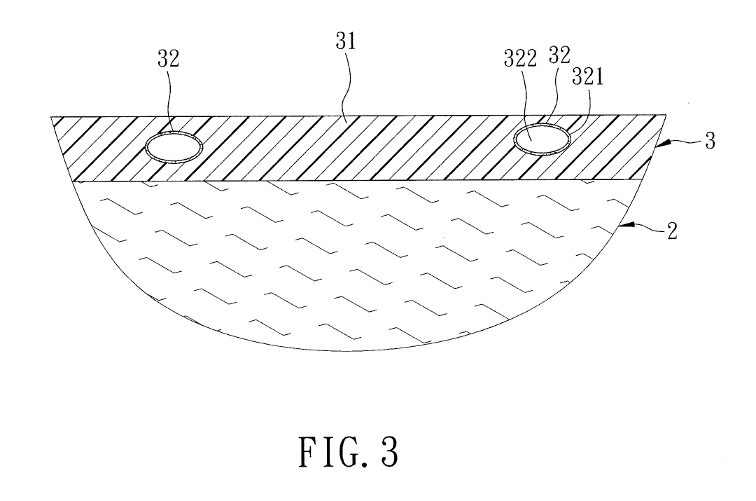

Referring to FIGS. 2 and 3, a semi-product for making artificial leather, includes a fabric substrate 2 and a coating layer 3. The fabric substrate 2 may be made from any fabric material suitable for making artificial leather. Examples of the fabric materials include TR, CVC, jersey, nonwoven cloth, woven cloth, dull velvet, etc.,

The coating layer 3 is applied to a surface 21 of the fabric substrate 2, and contains a mixture of a resin 31 and a gas bubble material 32 . The gas bubble material 32 is burstable under heat to cause the coating layer 3 to break into hairy filaments. In an example, the mixture includes 87-97% by weight of the resin, and 3-13% by weight of the gas bubble material. In another example, the resin is polyurethane, and the gas bubble material includes a plurality of gas bubbles each having an envelope film 321 enclosing a gas 322. Preferably, the gas 322 is an inert gas.

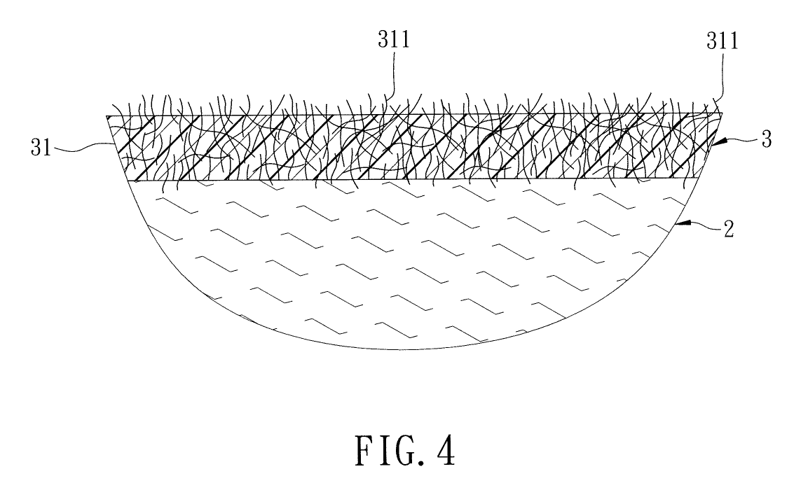

Referring to FIGS. 3 and 4, a method for making the semi-product and the artificial leather according to a preferred embodiment of the invention is as follows:

Firstly, the coating layer 3 is applied to the surface 21 of the fabric substrate 2. The gas bubble material 32 is dispersed in the resin 31 of the coating layer 3 as shown in FIG. 3. Application of the coating layer 3 may be conducted by employing a suitable conventional coating method. After the coating layer 3 is formed, the fabric substrate 2 and the coating layer 3 are heated until the gas bubble material 32 bursts and breaks the coating layer 3 to open irregularly and form hairy filaments 311 as shown in FIG. 4. The temperature for heating the fabric substrate 2 and the coating layer 3 may be of 150-180° C.

As described above, the hairy filaments 311 are formed by heating the gas bubble material 32 to burst and break the coating layer 3. The coating layer 3 is not treated with any mechanical means that contacts and/or rubs the surface of the coating layer 3. Accordingly, the original color and gloss of the coating layer 3 can be maintained, and the artificial leather made according to the present invention can have uniform color and gloss level. In addition, because the hairy filaments 311 are formed by bursting the gas bubble material 32, the material of the fabric substrate 2 need not be limited, and may be selected from a wide variety of fabric materials.

While the present invention has been described in connection with what is considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. A method of making artificial leather, comprising:
applying on a fabric substrate a coating layer that includes a mixture of a resin and a gas bubble material; and
heating the fabric substrate and the coating layer until the gas bubble material bursts and breaks the coating layer to open and form hairy filaments.

2. The method of claim 1, wherein the mixture includes 87-97% by weight of the resin, and 3-13% by weight of the gas bubble material.

3. The method of claim 1, wherein the fabric substrate and the coating layer are heated to a temperature of 150-180° C.

4. The method of claim 1, wherein the gas bubble material includes a plurality of gas bubbles each having an envelope film enclosing an inert gas.

5. A semi-product for forming artificial leather, comprising a fabric substrate, and a coating layer disposed on said fabric substrate, the coating layer including a mixture of a resin and a gas bubble material that is burstable under heat to cause the coating layer to break into hairy filaments.

6. The semi-product of claim 5, wherein said gas bubble material includes a plurality of gas bubbles each having an envelope film enclosing a gas.

7. The semi-product of claim 6, wherein the gas is an inert gas.

8. The semi-product of claim 5, wherein the mixture includes 87-97% by weight of the resin, and 3-13% by weight of the gas bubble material.
